(19) United States
(12) Patent Application Publication
(10) Pub. No.: US 2007/0264536 A1
(43) Pub. Date: Nov. 15, 2007

(54) BATTERY PACK FOR ELECTRIC TOOL

(76) Inventor: Toshio Mizoguchi, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/746,683

(22) Filed: May 10, 2007

(30) Foreign Application Priority Data
May 11, 2006 (JP) P2006-132520

(51) Int. Cl. H01M 2/10

(52) U.S. Cl. 429/9; 429/99; 429/123

(57) ABSTRACT

A battery pack for an electric tool storing a plurality of battery cells each having identical size, but size of the battery cell can be selected among a plurality of sizes. In a battery pack, a plurality of battery cells is packaged by a separator in at least two stages or tier. The battery case includes an upper case and a complementary lower case to define an internal space in which a board holder holding a circuit board is disposed. The board holder has first and second retainers fittable with an outer peripheral part of small size battery cell packaged by a first separator and an outer peripheral part of large size battery cell packaged by a second separator, respectively.

### BACKGROUND OF THE INVENTION

The present invention relates to a battery pack capable of storing a plurality of battery cells for an electric tool.

In an electric tool, a battery pack is detachably mounted to the tool body for supplying electric power to an electric motor housed in the tool body. The battery pack includes a battery case composed of upper and lower cases, and a separator disposed in the battery case for storing in the battery case a plurality of battery cells juxtaposed side by side in two horizontal rows overlapped with each other in a vertical direction. Further, a circuit board held by a board holder is accommodated in the upper case.

Further, various sizes of battery cells are used in such a battery pack. Therefore, a plurality of battery cases are prepared according to the sizes of battery cells to be used. Japanese Patent Application Publication No. 2000-277073 discloses a battery storage structure capable of storing a plurality of kinds of batteries in an electric equipment such as a flashlight using a plurality of batteries.

As described above, a plurality of battery cases are prepared for a battery pack for electric tool according to the sizes of battery cells to be used. Therefore, when a size of a battery cell is changed, a battery case should also be changed. Accordingly, it has not been easy to freely select a battery cell of desired size in accordance with the price fluctuation of battery calls and preference of the user.

Moreover, in the conventional battery pack for electric tool, a plurality of rows of battery cells are regularly arrayed and stacked in the battery case, and a circuit board is disposed on the stack of battery cells. Thus, the height of the battery case becomes inevitably large, resulting in a bulky battery pack. In addition, in the battery storage structure described in the Japanese Patent Application Publication, the same number of one of different size batteries, such as one of size D batteries, size C batteries, and size AA batteries are selectively stored in a common case. Therefore, the size of the battery case must be in conformance with the largest size batteries. Consequently, a bulky battery case is required.

### SUMMARY OF THE INVENTION

It is therefore, an object of the present invention to provide a battery pack for an electric tool capable of selectively receiving one of a plurality of kinds of plurality of battery cells, the plurality of kinds having a battery cell size different from one another.

Another object of the present invention is to provide a compact battery pack for an electric tool, the battery pack having battery case with a reduced height.

These and other objects of the present invention will be attained by a battery pack for use in combination with an electric tool having a tool body, the battery pack being detachably attached to the tool body. The battery pack includes a first case, a complementary second case, a separator, and a board holder. The complementary second case provides a battery case in combination with the first case. The battery case defines an upper space and a battery cell accommodation space below the upper space. The separator is disposed in the battery cell accommodation space to package a plurality of battery cells in a form of at least a first horizontal cell array and a second horizontal cell array stacked on the first horizontal cell array. The board holder holds a circuit board and is disposed in the upper space. The board holder has a first retainer capable of fitting with an outer peripheral part of a small size battery cell and a second retainer capable of fitting with an outer peripheral part of a large size battery cell.

In another aspect of the invention, there is provided a battery pack for use in combination with an electric tool having a tool body, the battery pack being detachably attached to the tool body. The battery pack includes the first case, the complementary second case, the separator, and the board holder. The battery case has an interior horizontal bottom surface defining a part of the battery cell accommodation space. A first one of the battery cells is positioned below the board holder in the first horizontal cell array and a second one of the battery cells is positioned below the board holder in the second horizontal cell array. The first one and the second one have a first axis and a second axis respectively. A first angle is provided by an intersection between the interior horizontal cell array and an imaginary first line extending between the first axis and the second axis. A third one of the battery cells is positioned beside the first one of the battery cells in the first horizontal cell array, and a fourth one of the battery cells is positioned beside the second one of the battery cells in the second horizontal cell array. The third one and the fourth one have a third axis and a fourth axis respectively. A second angle is provided by an intersection between the interior horizontal cell array and an imaginary second line extending between the third axis and the fourth axis. The first angle is smaller the second angle.

### BRIEF DESCRIPTION OF THE DRAWINGS

In the drawings;

FIG. 1 is a side view of an electric tool having a battery pack according to a first embodiment of the present invention;

FIG. 2 is an exploded perspective view of the battery pack according to the first embodiment;

FIG. 3 is a plan view of the battery pack according to the first embodiment;

FIG. 4 is a partially cut-away front view as viewed from an arrow IV of FIG. 3;

FIG. 5(a) is a cross-sectional side view showing a state where small size battery cells are stored in the battery pack according to the first embodiment;

FIG. 5(b) is a side view showing a separator that packages small size battery cells in the battery pack according to the first embodiment;

FIG. 6 is a cross-sectional side view showing a state where large size battery cells are stored in the battery pack according to the first embodiment;

FIG. 7 is a cross-sectional side view showing a state where small size battery cells are stored in a battery pack according to a second embodiment of the present invention; and,

FIG. 8 is a cross-sectional side view showing a state where large size battery cells are stored in the battery pack according to the second embodiment.

### DETAILED DESCRIPTION

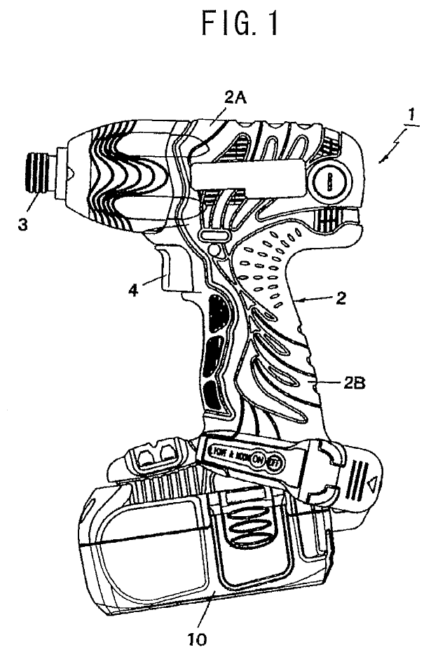

A battery pack for an electric tool according to a first embodiment of the present invention will be described with reference to FIGS. 1 through 6. An electric drill 1 is shown in FIG. 1 as the electric tool. The drill 1 has a housing 2 in generally T-shape configuration and including a main housing 2A and a handle housing 2B. That is, the handle housing 2B extends substantially perpendicularly from the main housing 2A. Throughout the specification, the main housing 2A side will be referred to an upper side and the handle housing 2B side will be referred to as a lower side.

In the main housing 2A, an electric motor (not shown) as a driving source is disposed. A drill chuck 3 is rotatably mounted at one end of the main housing 2A. Throughout the specification, the drill chuck 3 side will be referred to as a front side. Further, a transmission mechanism (not shown) is disposed in the main housing 2A for transmitting rotation of the motor to the drill chuck 3.

A trigger switch 4 is provided on an upper and front portion of the handle housing 2B. Further, a battery pack 10 is detachably mounted at a lower end of the handle housing 2B. That is, the handle housing 2B is formed with a receiving portion (not shown) to receive the battery pack 10. When the trigger switch 4 is turned ON, an electric current is supplied from the battery pack 10 to the electric motor (not shown) to drive the electric motor. The rotation of the electric motor is transmitted via the transmission mechanism (not shown) to the drill chuck 3 so as to rotationally drive a drill bit (not shown) mounted to the drill chuck 3, thereby performing a desired drilling operation.

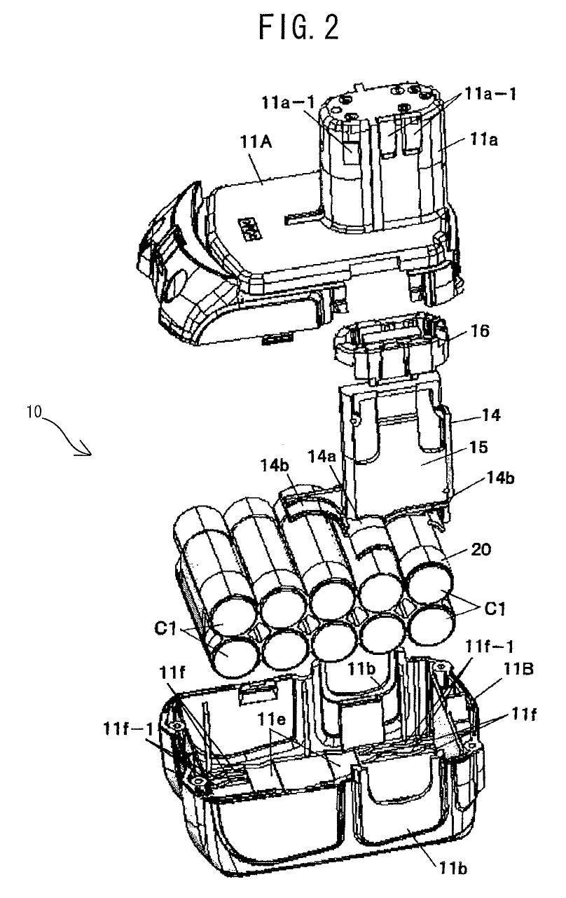

A configuration of the battery pack 10 will be described in detail with reference to FIGS. 2 through 6. As shown in FIG. 2, the battery pack 10 includes a sealed rectangular parallelepiped battery case 11 constructed by an upper case 11A and a lower case 11B those made from a resin. The lower case 11B is in the form of a rectangular box whose upper end is open. A pocket 11b is formed at right and left side walls of the lower case 11B. As shown in FIG. 4, a resilient locking piece 13 and a leaf spring 12 made from a metal are supported in each pocket 11b. The locking piece 13 is biased outward by the leaf spring 12. A snap latch 13a is formed at an upper end of each locking piece 13.

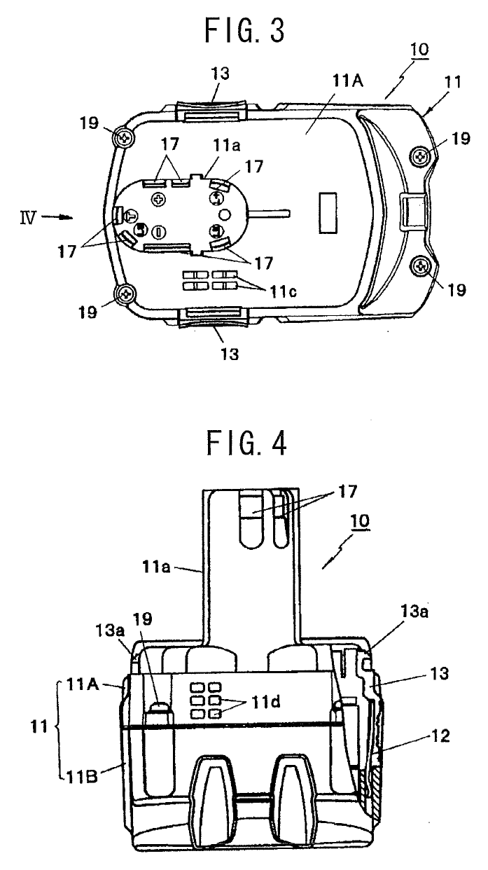

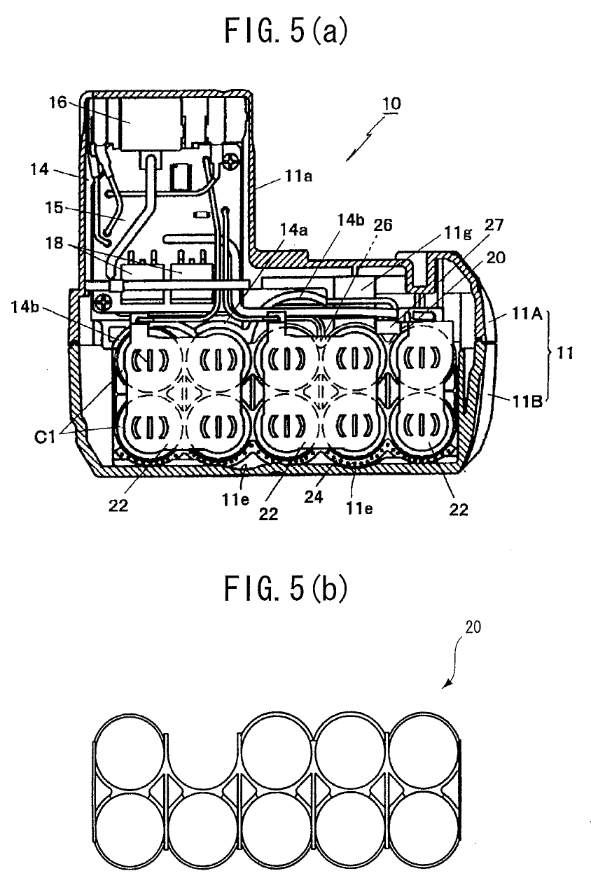

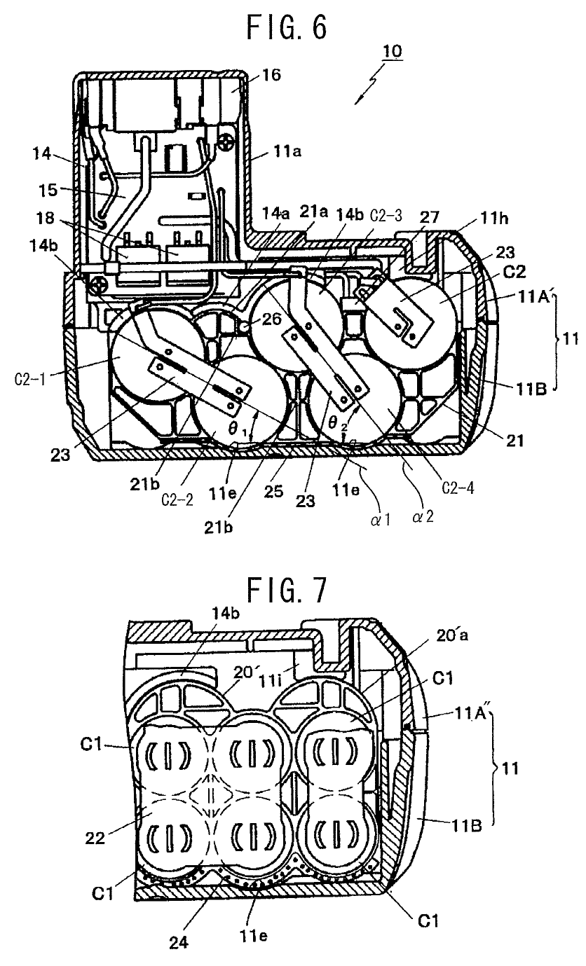

The upper case 11A is adapted for covering the upper end opening of the lower case 11B. The upper case 11A has an upper wall formed with a plurality of vent holes 11c (FIG. 3), and has a side wall formed with a plurality of vent holes 11d (FIG. 4). As described later, two kinds of upper cases 11A (FIG. 5(a)) and 11A′ (FIG. 6) are prepared. Outer configuration and outer dimension of the upper cases 11A and 11A′ is identical to each other. A thermistor 26 and a thermal protector 27 are provided in the upper case 11A, 11A′. The thermister 26 is one of electronic components of a temperature detector for detecting battery temperature during charging. The thermal protector 27 is adapted for shutting off charging circuit for stopping charging in order to avoid overheating to the batteries. That is, the thermal protector 27 is disposed in series in the charging circuit. When the battery temperature becomes abnormally high temperature during charging, a terminal of the thermal protector becomes open to shut off the charging path. If the charging is continued even at the high temperature of the battery due to the breakdown of the thermister, etc, the thermal protector 27 is shut off.

A tubular fitting section 11a having an elliptic cross-section integrally extends from the upper wall of the upper case 11A. The fitting section 11a is fittable with the receiving portion of the handle housing 2B. The fitting section 11a has an upper wall formed with a plurality of rectangular openings 11a-1. In the fitting section 11a, a board holder 14 made from a resin is accommodated, and a circuit board 15 is held to the board holder 14 with vertical orientation. Further, an elliptically shaped terminal holder 16 is fitted to an upper end portion of the circuit board 15. A plurality of terminals 17 are supported to the board holder 14, and each terminal 17 is exposed to an atmosphere through each rectangular openings 11a-1 (see also FIG. 3). As shown in FIGS. 5 and 6, the circuit board 15 has electronic components 18 such as FET.

For assembly of the battery case 11, the upper case 11A is put on the lower case 11B from above. Four corners of the upper case 11A are attached and fixed to the lower case 11B by screws 19, thereby providing an internal space. In this space, as shown in FIG. 5(a), ten small size battery cells C1 can be horizontally stored. Alternatively, as shown in FIG. 6, five large size battery cells C2 can be horizontally stored. Here, “horizontally stored” implies that each axis of each battery cell C1 and C2 is directed in the direction substantially parallel to a bottom surface of the battery case 11. The plurality of vent holes 11c serve as cooling air windows 11c for introducing ambient air for cooling into the internal space, and the plurality of vent holes 11d serve as windows for exhausting warm air in the internal space to the atmosphere.

As shown in FIGS. 2 and 5, the ten small size battery cells C1 are laid in a double-decker fashion, and five battery cells C1 are arrayed side by side in a horizontal direction, and each upper and lower batteries C1, C1 are vertically aligned. These battery cells C1 are held and packaged by a separator 20 made from a resin.

As shown in FIG. 6, regarding five large size battery cells C2, three cells are arranged in an upper stage or tier and two cells are arranged in a lower stage or tier. These battery cells C2 are held and packaged by another separator 21 made from a resin. The separator 21 includes an arcuate convex part 21a and a horizontally extending rib 21b those described later.

As shown in FIGS. 2, 5 and 6, at the lower end portion of the board holder 14, a first battery cell retainer 14a and a pair of second battery cell retainers 14b are provided. The first battery cell retainer 14a is positioned between the pair of second battery cell retainers 14b. The first battery cell retainer 14a has an arcuate recess whose radius is coincident with a radius of the small size battery cell C1. The pair of second battery cell retainers 14b have arcuate recesses whose radius is coincident with a radius of the large size battery cell C2.

As shown in FIGS. 2 and 6, in the inner surface of the bottom wall of the lower case 11B, two arcuate recesses 11e extend in an axial direction of the battery cells and are spaced away from each other in the frontward/rearward direction of the electric tool 1. Each arcuate recess 11e has a radius coincident with the radius of the large size battery cells C2.

As shown in FIG. 2, two rows of ribs 11f protrude from the inner surface of the bottom wall of the lower case 11B. Each two rows of ribs 11f is positioned at each widthwise end of the bottom wall and positioned close to the arcuate recess 11e. Each ribs 11f is formed with an arcuate recess 11f-1 whose radius is coincident with the radius of the small size battery cell C1. A cushion member 24 (FIG. 5(a)) or 25 (FIG. 6) is provided immediately above the bottom wall of the lower case 11B.

According to the present embodiment, two kinds of upper cases 11A and 11A′ are prepared. That is, the upper case 11A shown in FIGS. 1 through 5 is adapted for accommodating the small size battery cells C1, and the upper case 11A′ shown in FIG. 6 is adapted for accommodating the large size battery cells C2. In the upper case 11A shown in FIG. 5(a), a fitting protrusion 11g protrudes downward from the upper wall for fitting with an outer peripheral part of the small size battery cell C1. In the upper case 11A′ shown in FIG. 6, a fitting protrusion 11h protrudes downward from the upper wall for fitting with an outer peripheral part of the large size battery cell C2.

Incidentally, the small size battery cells C1 are lithium ion battery cells with a voltage of 3.6 V and a capacity of 1.5 Ah. Two lithium ion battery cells are connected in parallel to each other by a conductive plate 22. When a pair of parallelly connected battery cells C1 is connected together in series, a power output of 18 V and 3.0 Ah is obtained. The large size battery cells C2 are lithium ion batteries with a voltage of 3.6 V and a capacity of 3.0 Ah. These lithium ion battery cells are connected in series by a conductive plate 23, so that a power output of 18 V and 3.0 Ah is obtained.

With this arrangement, the ten small size battery cells C1 packaged by the separator 20 are stored in position in the battery case 11 as shown in FIG. 5(a). The cushion member 24 is provided between the battery cells C1 and the inner bottom portion of the lower case 11B. In this case, one of the second battery cell retainers 14b holds the upper leftmost battery cell C1, and the first battery cell retainer 14a holds the upper battery cell C1 neighboring the leftmost battery cell. Further, the fitting protrusion 11g of the upper case 11A fits onto the upper tier battery cell C1 neighboring the rightmost battery cell. Moreover, the lower battery cell neighboring the rightmost battery cell is retained by the recess 11e formed in the inner bottom portion of the lower case 11B through the cushion member 24. Furthermore, the lower leftmost and rightmost battery cells C1 are fitted with the recesses 11f-1 of the ribs 11f of the lower case 11B through the cushion member 24.

Consequently, the ten small size battery cells C1 packaged by the separator 20 are fitted with and held by the cell retainers 14a and 14b of the board holder 14, the fitting protrusion 11g of the upper case 11A, and the recess 11e of the lower case 11B, whereby the battery cells C1 are stored in stable position in the battery case 11.

On the other hand, the five large size battery cells C2 packaged by the separator 21 are stored in position in the battery case 11 as shown in FIG. 6. The cushion member 25 is provided between the battery cells C2 and the inner bottom portion of the lower case 11B. In this case, the second battery retainers 14b of the board holder 14 fit with the outer peripheral parts of the leftmost and center battery cells C2 on the upper tier in FIG. 6. The arcuate convex part 21a of the separator 21 fits with the first battery retainer 14a of the board holder 14. The fitting protrusion 11h of the upper case 11A′ fits with the rightmost battery cell C2 at the upper tier. Further, two battery cells C2 in the lower tier fit via the cushion member 25 with the recess 11e formed in the inner bottom portion of the lower case 11B.

Consequently, the five large size battery cells C2 packaged by the separator 21 are fitted with or held by the first and second battery retainers 14a and 14b of the board holder 14, the fitting protrusion 11h of the upper case 11A′ and the recess 11e of the lower case 11B. Thus, the battery cells C2 are stably stored in position in the battery case As shown in FIG. 6, the large size battery cells C2-1, C2-2 positioned below the circuit board 15 provide an angle θ1 which is an intersection angle between a line α1 and the bottom surface of the lower case 11B, in which the line α1 is a connection line between a center of the upper leftmost battery cell C2-1 and a center of the lower leftmost battery cell C2-2. Further, the battery cell C2-3 centrally positioned in the upper tier and the right side battery cell C2-4 at the lower tier provide an angle θ2 which is an intersection angle between a line α2 and the bottom surface of the lower case 11B, in which the line α2 is a connection line between a center of the upper intermediate battery cell C2-3 and a center of the lower right battery cell C2-4. Here, the angle θ1 is smaller than the angle θ2. That is, two large size battery cells C2-1, C2-2 of the upper and lower two tiers arranged below the circuit board 15 in the battery case 11 are stored more inclined toward a horizontal direction than the other large size battery cells C2-3, C2-4 of the upper and lower two tiers. With this arrangement, a height of the battery cell C2-1 can be reduced. As a result, the height of the battery case 11 can be reduced, realizing a small-sized and compact battery pack 10.

Moreover, as shown in FIG. 6, the ribs 21b of the separator 21 functions to maintain a distance between horizontally adjacent two battery cells C2-1 and C2-3, and between horizontally adjacent two battery cells C2-2 and C2-4. The rib 21b extends substantially parallel to a straight line connecting the centers of two horizontally adjacent battery cells C2-1 and C2-3.

Thus, in this manner, when the fitting section 11a of the battery pack 10 is fitted into the receiving portion of the handle housing 2B, the latches 13a of the left and right locking pieces 13 are locked in a groove (not shown) formed in the receiving portion, thereby installing the battery pack 10 to the handle housing 2B. Since the battery pack 10 stores ten small size battery cells C1 or the five large size battery cells C2, electric power can be supplied from the battery pack 10 to the electric motor.

As described above, in the depicted embodiment, both the small size battery cells C1 and the large size battery cells C2 can be stored irrespective of using the identical lower case 11B and the board holder 14. Accordingly, battery cells C1 or C2 of a desired size can be selectively used.

Moreover, the large size battery cells C2 of the upper and lower two tiers arranged below the circuit board 15 in the battery case 11 are arranged more inclined toward a horizontal direction than the other large size battery cells C2 of the upper and lower two tiers, thereby reducing the height thereof. As a result, the height of the battery case 11 can be reduced, realizing a small-sized and compact battery pack 10.

Further, both the small size battery cells C1 and the large size battery cells C2 are fitted with and held to the recesses of the first and second retainers 14a and 14b of the board holder 14, the fitting protrusions 11g and 11h of the upper case 11A and the recess 11e of the lower case 11B. Accordingly, the battery cells C1 and C2 can be stably stored in given position in the battery case 11. As a result, movement of the battery cells C1 and C2 in the battery case 11 due to the vibrations of the body of the electric tool 1 can be prevented. Particularly, in the present embodiment, the rigidity of the separator 21 for holding the large size battery cells C2 can be enhanced by the rib 21b, thereby reliably preventing the relative movement between the battery cells C2 due to the vibrations of the tool body, and preventing a damage to the conductive plate 23 which electrically connects adjacent battery cells C2 to each other. Since the rib 21b extends substantially parallel to a straight line connecting the centers of two horizontally adjacent battery cells C2, the relative movement of the battery cells C2 can be reliably prevented.

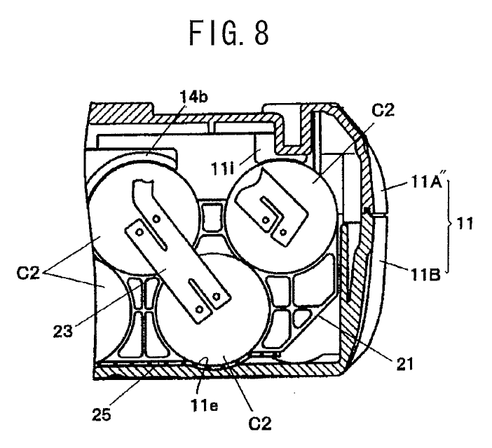

A battery pack according to a second embodiment of the present invention will be described with reference to FIGS. 7 and 8. FIG. 7 shows a state of a battery pack where small size battery cells are stored, and FIG. 8 shows a state of a battery pack where large size battery cells are stored. In these figures, like parts and components are designated by the same reference numerals as those shown in FIGS. 1 through 6 to avoid duplicating description.

In the second embodiment, there is formed in the upper case 11A″ a fitting protrusion 11i selectively fittable with a semicircular convex 20a′ as shown in FIG. 7 or an outer peripheral part of the large size battery cell C2 as shown in FIG. 8. The semicircular convex 20a′ is a part of a separator 20′ that holds the small size battery cells C1. The other configurations are the same as those of the first embodiment.

In the second embodiment, since the fitting protrusion 11i is fittable with either the outer peripheral surface of the large size battery cells C2 or the separator 20′ for holding the small size battery cells C1. Therefore, an upper case 11A″ as well as the lower case 11B are commonly available for both the small size battery cells C1 and the large size battery cells C2. Thus, the battery pack can be manufactured at lower cost.

While the invention has been described in detail and with reference to the specific embodiment thereof, it would be apparent to those skilled in the art that various changes and modifications may be made without departing from the scope of the invention. For example, in the above-described embodiment, the battery case is composed of complementary upper and lower cases. However, the battery case can be divided into left case and right case. Moreover, in the above embodiment, first and second retainers 14a, 14b those formed with recesses are provided to the board holder for holding the battery cells. Instead of the recess, the first and second retainers can be provided with convex portions for holding the battery cells.

What is claimed is:

1. A battery pack for use in combination with an electric tool having a tool body, the battery pack being detachably attached to the tool body and comprising:
a first case;
a complementary second case to provide a battery case in combination with the first case, the battery case defining an upper space and a battery cell accommodation space below the upper space;
a separator disposed in the battery cell accommodation space to package a plurality of battery cells in a form of at least a first horizontal cell array and a second horizontal cell array stacked on the first horizontal cell array; and
a board holder holding a circuit board and disposed in the upper space, the board holder having a first retainer capable of fitting with an outer peripheral part of a small size battery cell and a second retainer capable of fitting with an outer peripheral part of a large size battery cell.

2. The battery pack as claimed in claim 1, wherein the board holder has a lower end to which the first retainer and the second retainer are provided, the first retainer and the second retainer being exposed to the battery cell accommodation space.

3. The battery pack as claimed in claim 1, wherein the small size battery cell has a first radius, and the large size battery cell has a second radius different from the first radius; and
wherein the first retainer has a first arcuate shape whose radius is coincident with the first radius, and the second retainer has a second arcuate shape whose radius is coincident with the second radius.

4. The battery pack as claimed in claim 1, wherein the battery case has an interior horizontal bottom surface defining a part of the battery cell accommodation space; and
wherein the first horizontal cell array and the second horizontal cell array are provided by a plurality of the large size battery cells, first one of the large size battery cells positioned below the board holder in the first horizontal cell array and second one of the large size battery cells positioned below the board holder in the second horizontal cell array having a first axis and a second axis respectively, a first angle being provided by an intersection between the interior horizontal cell array and an imaginary first line extending between the first axis and the second axis;
a third one of the large size battery cells being positioned beside the first one of the large size battery cells in the first horizontal cell array, and a fourth one of the large size battery cells being positioned beside the second one of the large size battery cells in the second horizontal cell array, the third one of the large size battery cells and the fourth one of the large size battery cells having a third axis and a fourth axis respectively, a second angle being provided by an intersection between the interior horizontal cell array and an imaginary second line extending between the third axis and the fourth axis, the first angle being smaller the second angle.

5. The battery pack as claimed in claim 1, wherein the first case has a protrusion fitted with a part of the separator.

6. The battery pack as claimed in claim 1, wherein the separator has a rib that maintains a horizontal distance between neighboring battery cells in an identical horizontal cell array.

7. The battery pack as claimed in claim 6, wherein the rib extends in a direction substantially parallel to an imaginary line extending between an axis of the battery cell and an axis of a neighboring battery cell in the identical horizontal cell array.

8. A battery pack for use in combination with an electric tool having a tool body, the battery pack being detachably attached to the tool body and comprising:
a first case;
a complementary second case to provide a battery case in combination with the first case, the battery case defining an upper space and a battery cell accommodation space below the upper space;
a separator disposed in the battery cell accommodation space to package a plurality of battery cells in a form of at least a first horizontal cell array and a second horizontal cell array stacked on the first horizontal cell array; and
a board holder holding a circuit board and disposed in the upper space;
wherein the battery case has an interior horizontal bottom surface defining a part of the battery cell accommodation space;
wherein, a first one of the battery cells positioned below the board holder in the first horizontal cell array and second one of the battery cells positioned below the board holder in the second horizontal cell array have a first axis and a second axis respectively, a first angle being provided by an intersection between the interior horizontal cell array and an imaginary first line extending between the first axis and the second axis;
wherein a third one of the battery cells is positioned beside the first one of the battery cells in the first horizontal cell array, and a fourth one of the battery cells being positioned beside the second one of the battery cells in the second horizontal cell array, the third one of the battery cells and the fourth one of the battery cells having a third axis and a fourth axis respectively, a second angle being provided by an intersection between the interior horizontal cell array and an imaginary second line extending between the third axis and the fourth axis, the first angle being smaller the second angle.

9. The battery pack as claimed in claim 8, wherein the first case has a protrusion fitted with a part of the separator.

10. The battery pack as claimed in claim 8, wherein the separator has a rib that maintains a horizontal distance between neighboring battery cells in an identical horizontal cell array.

11. The battery pack as claimed in claim 10, wherein the rib extends in a direction substantially parallel to an imaginary line extending between an axis of the battery cell and an axis of a neighboring battery cell in the identical horizontal cell array.
